(19) United States
(12) Patent Application Publication
(10) Pub. No.: US 2018/0213156 A1
(43) Pub. Date: Jul. 26, 2018

(54) METHOD FOR DISPLAYING ON A SCREEN AT LEAST ONE REPRESENTATION OF AN OBJECT, RELATED COMPUTER PROGRAM, ELECTRONIC DISPLAY DEVICE AND APPARATUS

(71) Applicant: Parrot Air Support, Paris (FR)

(72) Inventors: Patrice Boulanger, Arcueil (FR); Giulio Pellegrino, Paris (FR); Louis-Joseph Fournier, Viroflay (FR)

(21) Appl. No.: 15/869,109

(22) Filed: Jan. 12, 2018

(30) Foreign Application Priority Data
Jan. 26, 2017 (FR) 17 50644

(51) Int. Cl. H04N 5/232; H04N 7/18; G06T 15/20; H04N 5/445

(52) U.S. Cl. CPC H04N 5/23293; H04N 7/183; B64C 39/024; H04N 5/44504; G06T 2200/24; G06T 15/205

(57) ABSTRACT

This method for displaying at least one representation of an object is implemented by an electronic display device, the method including the acquisition of a plurality of images of the object, wherein the acquired images correspond to different angles of view of the object; the calculation of a perspective model of the object from the plurality of images, and the display of the perspective model in a first mode; the method further including switching to a second mode upon detection of a selection by a user of a point on the model displayed in the first mode, the display of at least one of the acquired images in the second mode, the acquisition of at least one infrared image of the object, and upon the display in the second mode, at least one infrared image from the object is displayed in superimposition, at least partial, of the displayed acquired image.

### CROSS-REFERENCE TO RELATED APPLICATIONS

This application claims priority under 35 USC § 119 of French Application No. 17 50644, filed on January 26, 2017, which is incorporated herein by reference in its entirety.

### FIELD OF THE INVENTION

The present invention relates to a method for displaying at least one representation of an object on a screen.

The method is implemented by an electronic display device and comprises the acquisition of a plurality of images of the object, the acquired images corresponding to different angles of view of the object; the calculation of a perspective model of the object from the plurality of acquired images; and the display of the perspective model of the object on the display screen in a first display mode.

The invention also relates to a non-transitory computer-readable medium including a computer program comprising software instructions which, when executed by a computer, implement such a display method.

The invention also relates to a method for displaying at least one representation of an object on a screen.

The invention also relates to a method for displaying at least one representation of an object on a screen, wherein the apparatus comprises a display screen and such an electronic display device.

### BACKGROUND OF THE INVENTION

The invention relates to the field of displaying representations of an object on a display screen. The object is understood in the broad sense as any element capable of being imaged by an image sensor. The object may be, in particular, a building which may be overflown by a drone, wherein the acquired images are images taken by at least one image sensor equipping the drone.

The representation of an object may also be broadly understood as a view of the object that may be displayed on a display screen, whether it is, for example, an image taken by an image sensor and then acquired by the electronic display device for display, or a perspective model of the object, for example calculated by the electronic display device.

By perspective model, also referred to as a three-dimensional model or 3D model, is meant a representation of the outer envelope, or the outer surface, or the outer contour of the object, which is calculated by an electronic calculation module. In addition, when such a perspective model is displayed, the user is generally able to rotate this model about different axes in order to see the model of the object from different angles.

A display method of the aforementioned type is known. The perspective model of the object is calculated from previously acquired images of the object from different angles of view, wherein this model is then displayed on the screen, and the user is also able to rotate it about different axes in order to see it from different angles.

However, even if the display of such a model allows the user to better perceive the volume and the outer contour of the object, its usefulness is relatively limited.

### SUMMARY OF THE DESCRIPTION

The object of the invention is thus to propose a display method and a related electronic display device, which make it possible to offer additional functionality to the display of the perspective model.

To this end, the subject-matter of the invention is a method for displaying at least one representation of an object on a display screen, wherein the method is implemented by an electronic display device and comprises:
the acquisition of a plurality of images of the object, the acquired images corresponding to different angles of view of the object;
the calculation of a perspective model of the object from the plurality of images acquired;
the display of the perspective model of the object on the display screen in a first display mode;
the switching to a second display mode, upon detection of a selection by a user, of a point on the model displayed in the first mode;
the display of at least one of the images acquired on the display screen in the second mode;
the acquisition of at least one image of infrared radiation from the object, and during the display of at least one acquired image in the second mode, at least one acquired image of the infrared radiation of the object is displayed in at least partial superimposition on the displayed acquired image.

With the display method according to the invention, the display of the perspective model of the object allows the user to clearly perceive the volume and the external contour of the object in the first display mode.

Then, upon switching to the second display mode by selection by the user of a point on the model displayed according to the first mode, allows the viewer to view acquired images of the object directly in this second mode. This second display mode then allows the user to obtain more information on one or more points of the model by successively selecting each point and then by viewing the acquired images of the object corresponding to each point. In addition, each selected point is preferably marked with a marker on each displayed acquired image.

According to other advantageous aspects of the invention, the display method comprises one or more of the following features, taken separately or in any technically feasible combination:
during the display of at least one acquired image in the second mode, the selected point is referenced by a marker on each acquired image displayed;
during the display of at least one acquired image in the second mode, the acquired image displayed is visible transparently through the image of the infrared radiation that is displayed in superimposition;
during the display of at least one acquired image in the second mode, a frame is displayed in superimposition on the displayed acquired image, and an enlargement of the acquired image corresponding to the area of the image located inside the frame is also displayed on the display screen; the display of said frame being preferably controlled by an action of the user;
the position of the superimposed displayed frame is variable with respect to the displayed acquired image;
the variation of the position of said frame being preferably controlled as a result of an action of the user;
the object is a building suitable to be overflown by a drone, and the images acquired are images taken by at least one image sensor equipping the drone.

The invention also relates to a non-transitory computer-readable medium including a computer program comprising software instructions which, when executed by a computer, implement a display method as defined above.

The invention also relates to an electronic display device for the display of at least one representation of an object on a display screen, wherein the device comprises:
an acquisition module configured to acquire a plurality of images of the object, the images acquired corresponding to different angles of view of the object;
a calculation module configured to calculate a perspective model of the object from the plurality of acquired images;
a display module configured to display the perspective model of the object on the display screen in a first display mode;
a switching module configured to switch to a second display mode upon detection of a selection by a user of a point on the model displayed in the first mode;
the display module being configured to display at least one of the acquired images on the display screen in the second mode;
the acquisition module being further configured to acquire at least one image of infrared radiation from the object; and
the display module being configured to further display at least one acquired image of the infrared radiation from the object in at least partial superimposition on the displayed acquired image.

According to another advantageous aspect of the invention, the electronic display device comprises the following feature:
the device is a web server accessible via the Internet.

The invention also relates to an electronic apparatus for displaying at least one representation of an object on the display screen, wherein the apparatus comprises a display screen and an electronic display device, wherein the electronic display device is as defined above.

### BRIEF DESCRIPTION OF THE DRAWINGS

These features and advantages of the invention will appear more clearly upon reading the description which follows, given solely by way of non-limiting example, and with reference to the appended drawings, wherein:

FIG. 1 shows a schematic representation of an electronic display device according to the invention, wherein the apparatus comprises a display screen and an electronic display device for displaying at least one representation of an object on the screen, wherein the electronic display device comprises an acquisition module configured to acquire a plurality of images of the object, a calculation module configured to calculate a perspective model of the object from the images acquired, a display module configured to display the perspective model of the object on the screen in a first display mode, a switching module configured to switch to a second display mode upon detection of a selection of a point on the model displayed according to the first mode, wherein the display module is configured to display at least one of the images acquired on the screen in the second mode;

FIG. 2 shows a view of the perspective model of the object displayed according to the first display mode, wherein the object is a building;

FIGS. 3 to 5 show views of images displayed according to the second display mode from different viewing angles; and

FIG. 6 shows a flowchart of a display method according to the invention.

### DETAILED DESCRIPTION

In the following of the description, the expression “substantially constant” is understood as a relationship of equality plus or minus 10%, i.e. with a variation of at most 10%, more preferably as an equality relationship plus or minus 5%, i.e. with a variation of at most 5%.

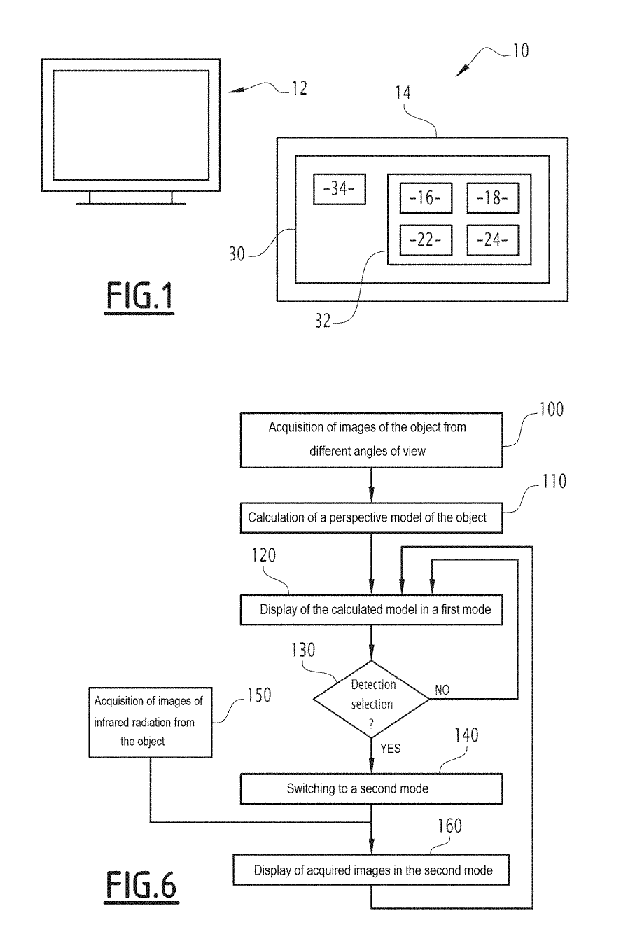

In FIG. 1, an electronic apparatus 10 for displaying at least one representation of an object comprises a display screen 12 and an electronic display device 14 for displaying at least one representation of the object on the display screen 12.

The display screen 12 is known per se.

The electronic display device 14 is configured to display at least one representation of the object on the display screen 12, wherein it comprises an acquisition module 16 configured to acquire a plurality of images of the object, wherein the acquired images correspond to different angles of view of the object.

The electronic display device 14 also comprises a calculation module 18 configured to calculate a perspective model 20 of the object from the plurality of acquired images, and a display module 22 configured to display the perspective model 20 of the object on the display screen 12 in a first display mode M1.

According to the invention, the electronic display device 14 further comprises a switching module 24 configured to switch to a second display mode M2 upon detection of a selection by a user of a point on the model 20 displayed in the first mode M1, wherein the display module 22 is then configured to display at least one of the acquired images on the display screen 12 in the second mode M2.

In the example of FIG. 1, the electronic display device 14 comprises an information processing unit 30, in the form, for example, of a memory 32 and a processor 34 associated with the memory 32.

Optionally in addition, the electronic display device 14 may be a web server accessible via the Internet.

In the example of FIG. 1, the acquisition module 16, the calculation module 18, the display module 22 and the switching module 24 are each in the form of software executable by the processor 34. The memory 32 of the information processing unit 30 is then able to store acquisition software configured to acquire a plurality of images of the object corresponding to different angles of view of the object, calculation software configured to calculate the perspective model 20 of the object from the plurality of acquired images, display software configured to display the model in perspective 20 on the display screen in the first display mode M1, as well as the acquired images of the object in the second display mode M2, and switching software configured to switch to the second display mode M2 upon detection of a selection by a user of a point on the model 20 displayed in the first mode M1. The processor 34 of the information processing unit 30 is then able to execute the acquisition software, the calculation software, the display software and the switching software.

In a variant (not shown), the acquisition module 16, the calculation module 18, the display module 22 and the switching module 24 are each made in the form of a programmable logic component, such as an FPGA (Field Programmable Gate Array), or in the form of a dedicated integrated circuit, such as an ASIC (Application Specific Integrated Circuit).

The acquisition module 16 is furthermore configured to acquire at least one image of infrared radiation from the object, while the display module 22 is configured to display at least one acquired image of the infrared radiation from the object superimposed, at least partially, on the displayed acquired image.

The calculation module 18 is configured to calculate the perspective model 20 of the object from the plurality of images acquired, wherein the calculation of the perspective model 20 is known per se and preferably carried out by photogrammetry.

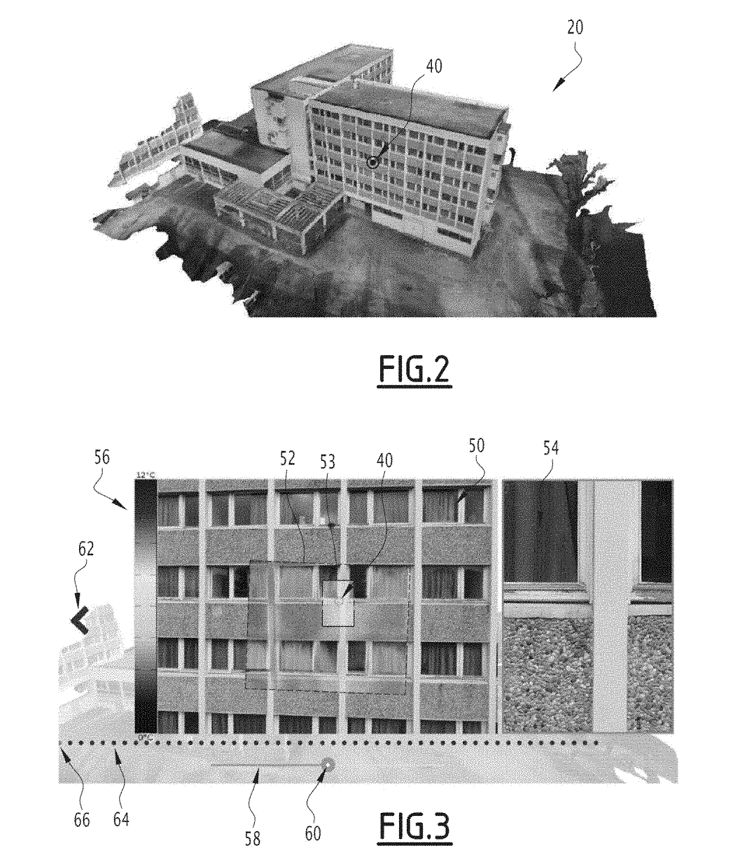

The perspective model 20, also called three-dimensional model, or 3D model, is a representation of the outer envelope, or outer surface, or outer contour, of the object, as shown in FIG. 2, wherein the object is a building.

The display module 22 is configured to display the perspective model 20 of the object in the first display mode M1, while the switching module 24 is configured to detect the selection by the user of a point on the model 20 displayed in the first mode M1. The switching module 24 is then configured to determine the coordinates P of the selected point in a predefined coordinate system, wherein this determination of the coordinates P of the selected point is known per se, and is preferably carried out using a software library for displaying the perspective model 20. Upon this detection, the switching module 24 is then configured to switch to the second display mode M2.

The display module 22 is then configured to display at least one of the acquired images in the second mode M2. In order to determine which acquired image(s) (50) is/are to be displayed among the plurality of acquired images, the display module (22) is then configured to recalculate the coordinates P′ of the selected point in the reference of the image sensor(s) and for each acquired image, for example by using the following equation:

P′=R^{t}×(P−T) (1)

where P′=(X′, Y′, Z′) represents the coordinates of the selected point in the frame of the image sensor(s);

P=(X, Y, Z) represents the coordinates of the selected point, in the predefined coordinate system, also called initial reference;

T=(Tx, Ty, Tz) represents the position of the image sensor(s), in the initial coordinate system, i.e. the coordinates of the center of the image sensor(s), in the initial coordinate system;

R is a 3×3 matrix representing the orientation of the image sensor(s) in the initial coordinate system, wherein R^{t} is the transpose of the matrix R.

The person skilled in the art will understand that P′, P and T are each a 3-coordinate vector, or a 3×1 matrix.

The person skilled in the art will note that if Z′ is negative, then this means that the selected point was behind the image sensor(s) for the corresponding acquired image, wherein this acquired image is then discarded. In other words, the display module 22 is then configured to ignore the corresponding acquired image when Z′ is negative, and not to display it in the second mode M2.

When Z′ is positive, the display module 22 is then configured to convert the coordinates P′ of the selected point into homogeneous coordinates, also called perspective projection, in the reference of the image sensor(s), for example by using the following equation:

$${p}^{′} = ( \begin{matrix}{u}^{′} \\ {v}^{′}\end{matrix} ) = ( \begin{matrix}\frac{{X}^{′}}{{Z}^{′}} \\ \frac{{Y}^{′}}{{Z}^{′}}\end{matrix} ) \qquad ( 2 )$$

where p′=(u′, v′) represents the homogeneous coordinates of the selected point, in the reference of the image sensor(s).

Optionally in addition, the display module 22 is then configured to correct distortions, such as tangential and radial distortions, of an optical lens arranged between the image sensor(s) and the object, wherein the lens serves to focus the light radiation emitted from the object in an object plane corresponding to the image sensor(s).

This correction of distortions is, for example, carried out using the following equations:

r=u′·u′+v′·v′ (3)

dr=1+r·RD1+r²·RD2+r³·RD3 (4)

dt0=2·TD1·u′·v′+TD2·(r+2·u′·u′) (5)

dt1=2·TD2·u′·v′+TD1·(r+2·v′·v′) (6)

u″=u′·dr+dt0 (7)

v″=v′·dr+dt1 (8)

where p″=(u″, v″) represents the homogeneous coordinates after correction of distortions, in the reference of the image sensor(s);

(RD1, RD2, RD3) represents the radial distortion of the optical lens; and

(TD1, TD2) represents the tangential distortion of the optical lens.

The display module 22 is configured to convert the homogeneous coordinates of the selected point, possibly with correction of the distortions due to the optical lens, into coordinates in the plane of the corresponding acquired image.

This conversion of the homogeneous coordinates into coordinates in the plane of the image is, for example, carried out using the following equations:

u=f·u″+Cx (9)

v=f·v″+Cy (10)

where p=(u, v) represents the coordinates, expressed in pixels in the plane of the corresponding acquired image, of the selected point, u denoting the position on the abscissa and v denoting the position on the ordinate;

f represents the focal length of the optical lens; and

(Cx, Cy) represents a main point in the corresponding acquired image, i.e. the point on which the optical lens is centered, wherein this point is close to the center of the image, i.e. substantially in the center of the image.

The person skilled in the art will of course understand that, when the correction of the distortions of the optical lens is not implemented, the conversion of the homogeneous coordinates into coordinates in the plane of the image is, for example, carried out at using the following equations:

u=f·u′+Cx (11)

v=f·v′+Cy (12)

The display module 22 is thus configured to calculate the coordinates in pixels in the plane of the acquired image of the projection of the selected point, starting from the coordinates P of the point selected in the predefined reference, provided by the switching module 24, wherein this calculation is carried out using equations (1) to (10) when the correction of the distortions of the optical lens is performed, or with the aid of equations (1) to (2), (11) and (12) when the distortion correction of the optical lens is not performed.

The display module 22 is then configured to determine whether or not the selected point belongs to the corresponding acquired image, for example by comparing the coordinates (u, v), calculated in pixels, with the dimensions, expressed in pixels, of the corresponding acquired image. For example, by noting respectively W and H the width and height of the corresponding acquired image, wherein the display module 22 is configured to determine that the selected point belongs to the corresponding acquired image, when the abscissa u belongs to the interval [0; VV] and the ordinate v simultaneously belongs to the interval [0; H].

Conversely, if the abscissa u does not belong to the interval [0; VV] or if the ordinate v does not belong to the interval [0; H], then the corresponding acquired image is discarded by the display module 22 for this selected point. In other words, the display module 22 is configured to ignore the corresponding acquired image when the abscissa u does not belong to the interval [0; VV] or when the ordinate v does not belong to the interval [0; H], and does not display said acquired image according to the second mode M2.

The display module 22 is then configured to display each acquired image 50 for which it has previously determined that the coordinates of the projection in the plane of the image of the selected point, are included in the acquired image, wherein this prior determination is performed as previously described.

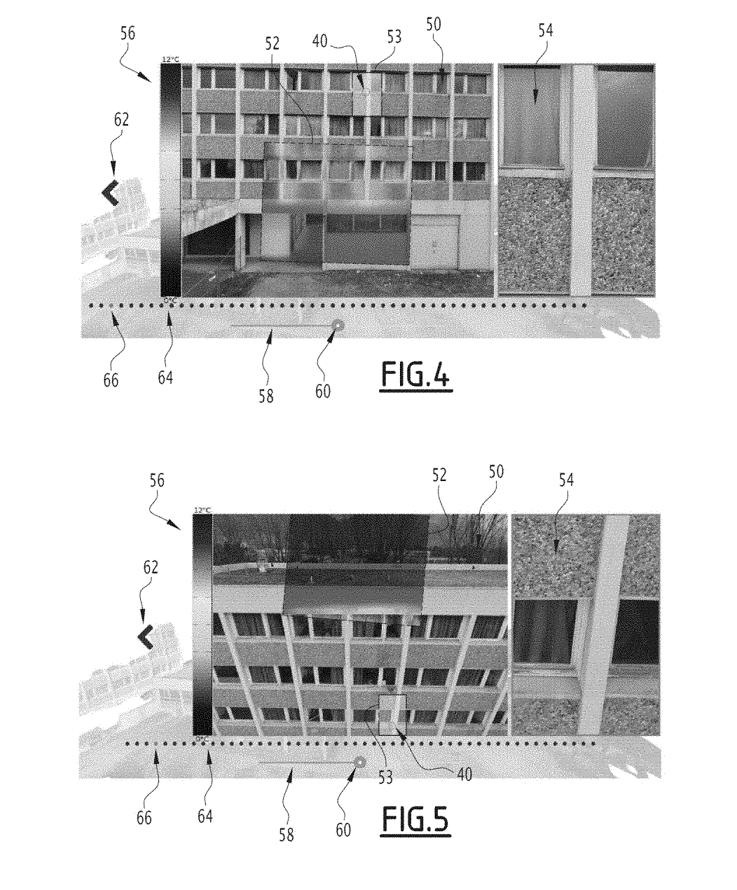

Optionally in addition, the display module 22 is configured to further display a marker 40 identifying the selected point, wherein the selected point is then referenced by the marker 40 on each displayed acquired image 50. In the example of FIGS. 2 to 5, the marker 40 is in the form of a circle centered on the selected point.

For the display according to the second mode M2 of the acquired image of the infrared radiation from the object 52, in at least partial superimposition of the displayed acquired image 50, the display module 22 is configured to adjust the positioning of the acquired image of infrared radiation, also called infrared image 52, with respect to the acquired image displayed, also called the RGB image 50, so that after positioning adjustment, the infrared image 52 (superimposed on the RGB image) and the RGB image 50 correspond to the same portion of the object.

For this positioning adjustment of the infrared image 52, the display module 22 is configured to identify a plurality of reference points in the RGB image 50, for example four reference points, and then to search for this plurality of reference points in the infrared image 52, and finally to calculate a positioning adjustment matrix between the infrared image 52 and the RGB image 50, from this plurality of reference points.

For example, the RGB image sensor for taking RGB images and the infrared sensor for taking infrared images are distinct and arranged in separate planes, especially when these sensors are embedded in a drone. The RGB image sensor and the infrared sensor may also have, for example, different sizes. It is necessary to transform the image taken by one type of sensor in order to superimpose it on the image taken by the other type of sensor, and, for example, to transform the infrared image 52 in order to superimpose it on the RGB image 50, and to determine a homography between the infrared image 52 and the corresponding RGB image 50 in this way.

For this purpose, the display module 22 is first configured to determine correspondences between the infrared images 52 and RGB images 50, for example by applying a Canny filter to the infrared image 52 and the corresponding RGB image 50. This Canny filter makes it possible to detect the contours of the main elements of the object in the infrared image 52 and in the corresponding RGB image 50.

The display module 22 is then configured to apply a Gaussian blur type filter to the infrared images 52 and RGB images 50 obtained after determination of the correspondences, for example after application of the Canny filter. The application of the Gaussian blur filter widens the contours.

The display module 22 is finally configured to implement a genetic algorithm to calculate the positioning adjustment matrix, also called the transformation matrix, between the infrared image 52 and the RGB image 50. The genetic algorithm involves, for example, choosing a gene, such as an abscissa, an ordinate, an angle, a scale, a trapezium, and then applying the homography associated with the gene to the infrared image 52 obtained after application of the Gaussian blur type filter, and superimposing the infrared image resulting from this homography on the RGB image 50 obtained after applying the Gaussian blur type filter. For the first iteration, the gene is for example taken at random. The genetic algorithm consists in determining the best gene. The genetic algorithm consists of calculating the sum of the intersections between the infrared image resulting from this homography and the RGB image 50, and finally selecting the gene for which the sum of said intersections is maximum. The transformation to be applied to the infrared image 52 in order to superimpose it on the RGB image 50 is then the transformation resulting from the homography associated with the selected gene.

Optionally in addition, the display module 22 is further configured to display the acquired image of the infrared radiation 52 with a non-zero transparency index, i.e. with an opacity index strictly less than 100%, so that the acquired displayed image 50, i.e. the displayed RGB image, is transparently visible through the image of the superimposed infrared radiation 52. The value of the transparency index for the display of the acquired image from the infrared radiation 52 is preferably parameterizable, for example a result of an input or action of the user.

In yet another optional addition, the display module 22 may be further configured to display a frame 53 superimposed on the displayed acquired image 50, as well as a magnification 54 of the acquired image corresponding to the area of the image located inside the frame 53, on the display screen 12 in the second mode M2. The display of said frame is preferably controlled as a result of an action of the user.

As a further optional addition, the position of the frame 53 displayed in superimposition, is variable relative to the displayed acquired image 50, wherein the variation of the position of said frame 53 is preferably controlled as a result of an action of the user.

The operation of the electronic display device 10 according to the invention, and in particular of the electronic display device 14, will now be explained using the example of FIGS. 2 to 5, as well as FIG. 6 which shows a flowchart of the display method according to the invention.

In the example of FIGS. 2 to 5, the object is a building suitable to be overflown by a drone, wherein the acquired images are images taken by at least one image sensor equipping the drone.

During the initial step 100, the electronic display device 14 begins by acquiring a plurality of images of the object via its acquisition module 16, wherein these images will have been taken from different angles of view.

In the next step 110, the electronic display device 14 calculates, with the aid of its calculation module 18, the perspective model 20 of the object, wherein this calculation is preferably effected by photogrammetry. A view of the perspective model 20 of the building, forming the object in the example described, is shown in FIG. 2.

The electronic display device 14 then proceeds to step 120 in order to display, on the display screen 12 and via its display module 22, the perspective module 20 according to the first display mode M1.

The user then sees a view of the type of that of FIG. 2, and the user also has the possibility of rotating this model in perspective about different axes, in order to see the perspective model of the object from different angles of view. The user further has the possibility in this first display mode M1 of selecting any point of the perspective model 20, wherein this selection is, for example, carried out using a mouse, or a stylus, or by tactile touch when the display screen 12 is a touch screen.

The electronic display device 14 then proceeds to step 130 to determine whether the selection of a perspective model point 20 has been detected. As long as no point selection has been detected, the perspective model 20 remains displayed according to the first display mode M1 (step 120), while the electronic display device 14 proceeds to the next step 140 as soon as the selection of a perspective model point 20 is detected.

In step 140, the switching module 24 then switches to the second display mode M2, wherein at least one of the acquired images is displayed.

In step 150, images of infrared radiation 52 of the object are also acquired by the acquisition module 16.

The electronic display device 14 then goes to step 160 and the acquired images are displayed in the second display mode M2.

In order to determine which RGB image(s) 50 is/are to be displayed in the second display mode M2, the display module 22 then calculates the coordinates in pixels in the plane of the acquired image of the projection of the selected point, from the coordinates P of the point selected in the predefined reference provided by the switching module 24. This calculation is, for example, carried out using equations (1) to (10) when the correction of the distortions of the optical lens is performed, or using equations (1) to (2), (11) and (12) when the distortion correction of the optical lens is not implemented.

The display module 22 then determines whether the selected point belongs to the corresponding acquired image or not, for example by comparing the computed coordinates (u, v) with the dimensions of the corresponding acquired image.

The display module 22 then displays each acquired image 50 for which it has previously determined that the coordinates of the projection in the plane of the image of the selected point are included in the acquired image, and preferably by identifying the selected point using the marker 40.

For the additional display of the infrared image 52 during the step 160 in this second mode M2, the display module 22 adjusts the positioning of the infrared image 52 relative to the RGB image 50, so that after adjustment of the position, the infrared image 52 (superimposed on the RGB image) and the RGB image 50 correspond to a same portion of the object, as shown in FIGS. 3 to 5.

For this positioning adjustment of the infrared image 52 with respect to the RGB image 50, the display module 22 applies, for example, the Canny filter to the infrared image 52 and the corresponding RGB image 50, then the Gaussian blur type filter to the infrared images 52 and the RGB images 50 resulting from this Canny filtering, and finally implements the genetic algorithm described above.

The transformation of the infrared image 52 resulting from these calculations is particularly effective for automatically and quickly determining the correct positioning of the infrared image 52 relative to the RGB image 50.

Optionally in addition, when displaying the infrared image 52 in the second mode, the display module 22 also displays a temperature scale 56 corresponding to the colors, or gray levels, used for the infrared image, so that the user may estimate which temperature corresponds to a given area of the infrared image. In the example of FIGS. 3 to 5, the temperature scale corresponds to temperatures between 0° C. and 12° C., while the infrared image 52 is surrounded by a dotted line frame which is only on the drawings in order to be more visible. The dotted line surrounding the infrared image 52 therefore does not appear on the display screen 12 when the infrared image 52 is superimposed on the RGB image 50.

As a further optional addition, the display module 22 displays, on the display screen 12 and in the second mode M2, the frame 53 superimposed on the displayed acquired image 50, as well as the enlargement 54 of the acquired image corresponding to the area of the image located inside the frame 53.

The display of said frame is preferably controlled as a result of an action of the user, such as a movement of the cursor associated with the mouse over the displayed acquired image 50. The position of the displayed superimposed frame 53 is more variable with respect to the displayed acquired image 50, wherein this position of said frame 53 is preferably controlled as a result of an action of the user, and wherein the position of the frame 53 depends, for example, directly on the position of the cursor associated with the mouse, while the frame 53 is displayed, for example, according to the movement of the cursor of the mouse from the moment when it is above the displayed acquired image 50. In the example of FIGS. 3 to 5, the frame 53 is represented as a discontinuous line only on the drawings in order to be more visible. The discontinuous line around the periphery of the frame 53 therefore does not appear on the display screen 12 when the frame 53 is displayed in superimposition on the RGB image 50.

Optionally in addition, the display module 22 also displays an opacity scale 58 with a slider 60 to adjust the opacity index of the infrared image 52, wherein the opacity index is the complement of the transparency index. In the example of FIGS. 3 to 5, the maximum value of the opacity index corresponds to the rightmost position of the adjustment slider 60, as represented in FIGS. 3 to 5, while the minimum value of the opacity index corresponds to the leftmost position of the adjustment slider 60. For the maximum value of the opacity index, the area of the RGB image 50 under the superimposed infrared image 52 is not, or only slightly, transparently visible, while, on the other hand, for the minimum value of the opacity index, the infrared image 52 displayed in superposition of the RGB image 50 is totally or almost completely transparent, and therefore very little visible. The person skilled in the art will of course understand that the maximum value of the opacity index corresponds to the minimum value of the transparency index, and vice versa, wherein the minimum value of the opacity index corresponds to the maximum value of the transparency index.

Optionally in addition, the display module 22 also displays two navigation cursors 62, a frieze 64 relating to the displayed acquired images 50, wherein an indicator 66 of the acquired image 50 is displayed. Each navigation cursor 62 allows the user to switch from a displayed acquired image 50 to the next one, in one direction or the other, while only the left navigation cursor 62 is visible in FIGS. 3 to 5, wherein this cursor allows one to go back among the displayed acquired images 50, corresponding to a displacement to the left of the indicator 66 on the frieze 64.

Thus, with the display method according to the invention, the switching to the second display mode, as a result of a selection by the user of a point on the model displayed according to the first mode, allows the user to directly visualize images acquired of the object in this second mode. This second display mode then provides more information on one or more points of the model by successively selecting each point, and then viewing the acquired images of the object corresponding to each point. In addition, each selected point is preferably referenced with a marker on each displayed acquired image.

When an infrared image 52 is further displayed superimposed on the displayed RGB image 50, the display method and the electronic display device 14 according to the invention provide even more information to the user, by providing additional thermal information relating to the object being viewed.

It is thus conceivable that the display method and the electronic display device 14 according to the invention make it possible to offer additional functionality to the display of the model in perspective, and, in particular, to identify more easily the different thermal zones of the object, and to identify, for example, thermal anomalies of the object, such as a lack of insulation on a building.

1. Method for displaying at least one representation of an object on a display screen, wherein the method is implemented by an electronic display device and comprises:
the acquisition of a plurality of images of the object, the acquired images corresponding to different angles of view of the object;
the calculation of a perspective model of the object from the plurality of acquired images;
the display of the perspective model of the object on the display screen in a first display mode;
the switching to a second display mode upon detection of a selection by a user of a point on the model displayed in the first mode;
the display of at least one of the acquired images on the display screen in the second mode;
the acquisition of at least one image of infrared radiation of the object; and
during the display in the second mode of at least one acquired image, at least one acquired image of the infrared radiation from the object is displayed in at least partial superimposition on the displayed acquired image.

2. Method for displaying according to claim 1, wherein, during the display of at least one acquired image in the second mode, the selected point is referenced by a marker on each displayed acquired image.

3. Method for displaying according to claim 1, wherein, during the display of at least one acquired image in the second mode, the displayed acquired image is transparently visible through the image from the infrared radiation that is displayed in superimposition.

4. Method for displaying according to claim 1, wherein, during the display of at least one acquired image in the second mode, a frame is displayed in superimposition on the displayed acquired image, and
an enlargement of the acquired image corresponding to the area of the image located inside the frame is also displayed on the display screen.

5. Method for displaying according to claim 4, wherein the display of said frame is controlled as a result of an action of the user.

6. Method for displaying according to claim 4, wherein the position of the superimposed frame is variable with respect to the displayed acquired image.

7. Method for displaying according to claim 6, wherein the variation of the position of said frame is controlled as a result of an action of the user.

8. Method for displaying according to claim 1, wherein the object is a building suitable to be overflown by a drone, and the acquired images are images taken by at least one image sensor equipping the drone.

9. Non-transitory computer-readable medium including a computer program comprising software instructions which, when executed by a computer, implement a method according to claim 1.

10. Electronic display device for displaying at least one representation of an object on a display screen, wherein the device comprises:
an acquisition module configured to acquire a plurality of images of the object, the acquired images corresponding to different angles of view of the object;
a calculation module configured to calculate a perspective model of the object from the plurality of acquired images;
a display module configured to display the perspective model of the object on the display screen in a first display mode;
a switching module configured to switch to a second display mode upon detection of a selection by a user of a point on the model displayed in the first mode;
the display module being configured to display at least one of the images acquired on the display screen in the second mode,
the acquisition module being further configured to acquire at least one image of infrared radiation from the object, and
the display module being configured to further display at least one acquired image of the infrared radiation from the object in at least partial superimposition on the displayed acquired image.

11. Device according to claim 10, wherein the device is a web server accessible via the Internet.

12. Electronic apparatus for displaying at least one representation of an object, wherein the apparatus comprises:
a display screen; and
an electronic device for displaying at least one representation of the object on the display screen,
wherein the electronic display device is according to claim 10.
